(19) United States
(12) Patent Application Publication
(10) Pub. No.: US 2023/0318632 A1
(43) Pub. Date: Oct. 5, 2023

(54) SOFTWARE-DEFINED RADIO DEVICE, METHOD FOR AVOIDING LINE QUALITY DEGRADATION, AND PROGRAM FOR AVOIDING LINE QUALITY DEGRADATION

(71) Applicant: NIPPON TELEGRAPH AND TELEPHONE CORPORATION, Tokyo (JP)

(72) Inventors: Toshifumi MIYAGI, Musashino-shi, Tokyo (JP); Kazuo OSAKA, Musashino-shi, Tokyo (JP); Hiroyuki FURUYA, Musashino-shi, Tokyo (JP); Hitoshi HASEGAWA, Musashino-shi, Tokyo (JP); Hayato FUKUZONO, Musashino-shi, Tokyo (JP); Fumiaki NAGASE, Musashino-shi, Tokyo (JP); Yu ONO, Musashino-shi, Tokyo (JP); Keita KURIYAMA, Musashino-shi, Tokyo (JP)

(73) Assignee: NIPPON TELEGRAPH AND TELEPHONE CORPORATION, Tokyo (JP)

(21) Appl. No.: 18/024,529

(22) PCT Filed: Sep. 8, 2020
(86) PCT No.: PCT/JP2020/033994

§ 371 Date: Mar. 3, 2023

(51) Int. Cl. H04B 1/00

(52) U.S. Cl. CPC H04B 1/0003

(57) ABSTRACT

Provided is a software wireless device capable of continuing communication without being affected by quality deterioration of a wireless line and without discarding of traffic data. The data to be transmitted is duplicated and wirelessly transmitted over a plurality of communication lines having different frequency bands (step 104). The received data received by the communication line having the best line quality is validated. Another frequency band that is different from the frequency band used in the plurality of communication lines and can provide line quality exceeding a determination criteria is searched (step 106). When the quality of the communication line communicating the same data deteriorates (step 108), the communication on that line is switched to the wireless communication on the additional communication line using the other frequency band (step 110).

### TECHNICAL FIELD

The present disclosure relates to a software wireless device, a method for avoiding deterioration of line quality, and a program for avoiding deterioration of line quality, and in particular, a software wireless device, a method for avoiding deterioration of line quality, and a program for avoiding deterioration of line quality, which are suitable for avoiding deterioration of line quality of wireless communication.

### BACKGROUND ART

PTL 1 discloses a line control method in a redundant configuration of a multiplex wireless device utilizing a link aggregation technique. In the invention disclosed in Patent Literature 1, switching control to a wireless standby line and link aggregation control are integrated, and thereby deterioration in line quality is sensed and the time required for switching the wireless line is shortened. As a result, the wireless device and a method for reducing the amount of traffic data to be discarded are realized.

### CITATION LIST

### Patent Literature

[PTL 1] Japanese Patent Application Publication No. 2012-124596

### SUMMARY OF INVENTION

### Technical Problem

In the above-described conventional invention, it is necessary to transmit a switching control request to an opposite wireless device and to return a response to the end of switching by the opposite wireless device which has received the request when switching the wireless line. The traffic is discarded during the period during which the procedure is executed.

In addition, although the quality of the wireless line of the switching destination can be determined in the above-described conventional invention, when it is determined that quality of many of the wireless lines of the switching destination has deteriorated, there is a situation in which the switching of the wireless line becomes difficult.

A first object of the present disclosure is to provide a software wireless device capable of utilizing software wireless technology to continue communication without discarding traffic data even when quality deterioration of a wireless line occurs in a specific communication system.

A second object of the present disclosure is to provide a method for utilizing software wireless technology to avoid deterioration of line quality for connection without discarding traffic data even when quality deterioration of a wireless line occurs in a specific communication system.

A third object of the present disclosure is to provide a program for utilizing software wireless technology to avoid deterioration of line quality for continuing communication without discarding traffic data even when quality deterioration of a wireless line occurs in a specific communication system.

### Solution to Problem

In order to achieve the above objectives, a first aspect of the present invention is a software wireless device including hardware resources for wireless communication that can be reconfigured by changing software, a memory storing software for making the hardware resources compatible with wireless communication, and a control unit that reconfigures the hardware resources using the software stored in the memory, and it is preferable that the control unit execute processing of configuring communication resources responsible for wireless communication on a plurality of communication lines with different frequency bands, processing to transmit the same data items on the plurality of communication lines, processing of handling data received by a communication line having the best line quality among a plurality of communication lines receiving the same data items as valid data, processing of searching for another frequency band different from the frequency band used in the plurality of communication lines and capable of providing line quality exceeding a determination criterion, processing of configuring a communication resource responsible for wireless communication on the additional communication line using the other frequency band, and processing of switching one of the plurality of communication lines to the additional communication line.

In addition, a second aspect is a method for avoiding deterioration of line quality using hardware resources for wireless communication that can be reconfigured by changing software and software for making the hardware resources compatible with wireless communication, the method including a control step of reconfiguring the hardware resources using the software, and it is preferable that the control step include a step of configuring communication resources responsible for wireless communication on a plurality of communication lines with different frequency bands, a step of transmitting the same data items on the plurality of communication lines, a step of handling data received by a communication line having the best line quality among a plurality of communication lines receiving the same data items as valid data, a step of searching for another frequency band different from the frequency band used in the plurality of communication lines and capable of providing line quality exceeding a determination criterion, a step of configuring a communication resource responsible for wireless communication on the additional communication line using the other frequency band, and a step of switching one of the plurality of communication lines to the additional communication line.

In addition, a third aspect is a program for avoiding deterioration of line quality, and it is preferable that the computer include a program for realizing the function of the software wireless device of the first aspect.

### Advantageous Effects of Invention

According to the first to third aspects, the hardware resources can be changed appropriately to a state suitable for achieving desired communication by changing software. Then, the same data is transmitted through a plurality of communication lines and the reception data of the most excellent communication line is validated, so that the influence of temporary deterioration in line quality can be eliminated. Further, by switching a line used for the duplicate communication of data to a line having line quality exceeding the determination criterion, excellent duplicate transmission is continued steadily. Thus, according to the present aspects, even if the quality of the wireless line deteriorates, excellent communication can be continued without discarding traffic data.

### BRIEF DESCRIPTION OF DRAWINGS

FIG. 1 is a diagram illustrating a configuration of a software wireless device according to Embodiment 1 of the present disclosure.

FIG. 2 is a block diagram for illustrating elements configured inside the software wireless device illustrated in FIG. 1.

FIG. 3 is a flowchart for illustrating content of processing executed by the software wireless device illustrated in FIG. 2.

FIG. 4 is a diagram illustrating a configuration of a software wireless device according to Embodiment 2 of the present disclosure.

FIG. 5 is a block diagram for illustrating elements configured inside the software wireless device illustrated in FIG. 4.

FIG. 6 is a flowchart for illustrating content of processing executed by the software wireless device illustrated in FIG. 5.

FIG. 7 is a diagram illustrating a configuration of a software wireless device according to Embodiment 3 of the present disclosure.

FIG. 8 is a block diagram for illustrating elements configured inside the software wireless device illustrated in FIG. 7.

FIG. 9 is a flowchart for illustrating content of processing executed by the software wireless device illustrated in FIG. 8.

### DESCRIPTION OF EMBODIMENTS

### Embodiment 1

[Configuration of Embodiment 1]

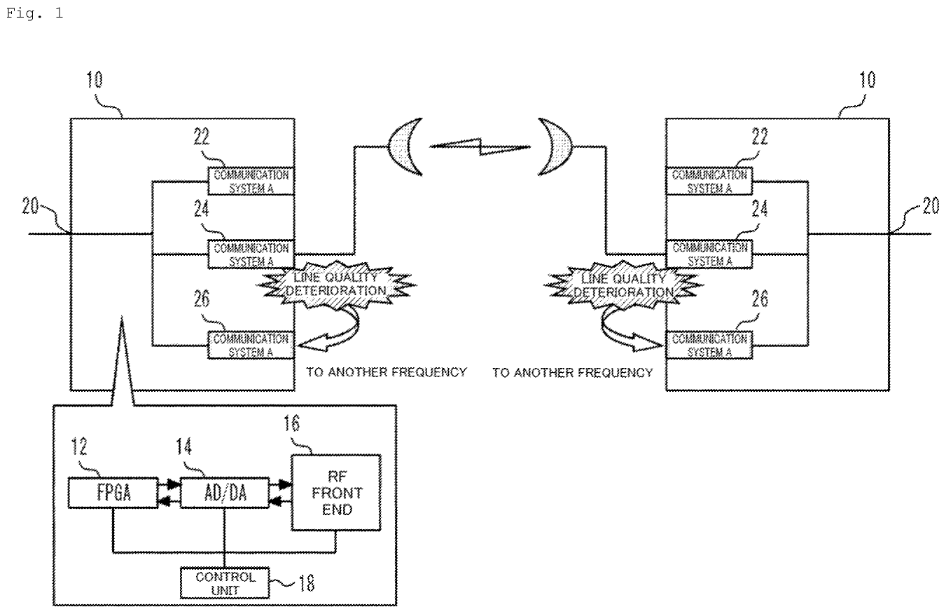

FIG. 1 illustrates a software wireless device 10 according to Embodiment 1 of the present invention. More specifically, FIG. 1 illustrates a state where two software wireless devices 10 having the same configuration communicate with each other via wireless signals.

The software wireless device 10 includes hardware which can be reconfigured by software, and can change a frequency band and a communication system used for wireless communication as needed. The software wireless device 10 can be used as a base station of mobile communication, for example.

As illustrated in FIG. 1, the software wireless device 10 includes a field programmable gate array (FPGA) 12. The FPGA 12 is a device capable of programming a configuration of various logic circuits by rewriting software. In the software wireless device 10, the FPGA 12 functions as a baseband processing unit for processing a baseband signal transmitted by communication. The FPGA 12 may be replaced by a general computer or a digital signal processor (DSP).

The software wireless device 10 includes an AD/DA converter 14 and an RF front end unit 16. The AD/DA converter 14 and the RF front end unit 16 process a high frequency signal between a communication antenna (not illustrated) and the FPGA 12.

The software wireless device 10 further includes a control unit 18. The control unit 18 incorporates various interfaces, a CPU, a memory, and the like. The control unit 18 controls the FPGA 12, the AD/DA converter 14, and the RF front end unit 16 by advancing processing according to a program stored in a memory. Specifically, the control unit 18 detects the state of communication required for the software wireless device 10, and reconfigures hardware corresponding to the state.

As illustrated in FIG. 1, the software wireless device 10 includes a wired terminal 20. The wired terminal 20 is connected to an external device via a transmission line. The software wireless device 10 transmits and receives a voice signal or a digital data signal to and from an external device through the wired terminal 20.

The software wireless device 10 can change the communication system by reconfiguring hardware. In the example illustrated in FIG. 1, a communication system A (for example, a WiFi (registered trademark) system or an LTE system) is adopted in both software wireless devices 10.

The software wireless device 10 can also change a frequency band used for communication, the number of frequency bands, and the width of the frequency band. In the example illustrated in FIG. 1, three rectangular frames 22, 24 and 26 described as “communication system A” are illustrated in two software wireless devices 10. These rectangular frames 22, 24 and 26 represent the frequency band of the communication line constituted in the software wireless device 10.

More specifically, the positions of the rectangular frames 22, 24, 26 in the vertical direction in the figure represent the height of the “frequency band”. In addition, the vertical widths of the rectangular frames 22, 24, and 26 represent the “widths” of the respective frequency bands. That is, the three rectangular frames 22, 24 and 26 illustrated in FIG. 1 show the following three events.

1. Three communication lines corresponding to the rectangular frames 22, 24 and 26 are prepared in the software wireless device 10 by the reconfiguration of hardware. Hereinafter, the rectangular frames 22, 24, 26 are referred to as “communication lines 22, 24, and 26” for convenience.

2. The communication lines 22, 24, and 26 use different frequency bands, and the frequency bands decrease in the order of the communication lines 22-24-26.

3. Frequency band widths of the communication lines 22, 24 and 26 are all the same.

[Feature of Embodiment 1]

The software wireless device 10 illustrated in FIG. 1 has the following functions.

1. The data input from the wired terminal 20 is duplicated and provided to both of the communication lines 22 and 24. The communication lines 22 and 24 transmit the same data wirelessly in different frequency bands having equal widths. Since the widths of the frequency bands are the same, the two communication lines 22 and 24 can transmit data with the same transmission capacity.

2. The software wireless device 10 on a receiving side determines the quality of the reception line for each of the communication lines 22 and 24.

3. The software wireless device 10 on the receiving side outputs only the data of the communication line whose quality is superior among the data items received by the two communication lines 22 and 24 to the wired terminal 20.

When the same data is communicated through a plurality of communication lines 22 and 24 and only signals of lines with good quality is utilized, the communication quality of the data can be maintained even if the quality of any line temporarily deteriorates due to a change in communication environment or the like. Therefore, the software wireless device 10 of the present embodiment can effectively suppress the occurrence of packet loss due to deterioration in communication quality.

4. The software wireless device 10 on the receiving side notifies the software wireless device 10 of a transmission source of the determination result about the quality of the reception line.

5. Upon receiving the notification of quality deterioration on one of the two communication lines 22 and 24 used for communication, the software wireless device 10 of the transmission source scans another frequency band capable of providing excellent line quality.

6. When a frequency band capable of providing excellent line quality is found, the frequency band is reported to the software wireless device 0 on the receiving side by a predetermined wireless communication system.

7. Thereafter, the communication line whose quality has deteriorated is switched to the communication line of a new frequency band, and the state where the same data is transmitted in duplicate by the plurality of communication lines is maintained.

FIG. 1 illustrates an example in which the communication line 26 is constructed as a line satisfying the condition as a result of scanning “a frequency band capable of providing good line quality” due to deterioration of the line quality of the communication line 24. In the present embodiment, a frequency band having the same frequency band width as the deteriorated communication line 24 is scanned. Therefore, the frequency band width of the communication line 26 is the same as that of the communication line 24. In the present embodiment, the same transmission capacity is secured before and after the line is switched in this manner.

According to the above-mentioned function, it is possible to continuously eliminate the influence caused by the deterioration of the line quality without instantaneous interruption, and to maintain a good communication state. Therefore, the software wireless device 10 of the present embodiment can continuously provide stable communication quality which is not affected by environmental variations or the like.

8. The software wireless device 10 of the present embodiment has a function of monitoring hardware resources such as a CPU and a memory. Then, when a situation of resource shortage in which a margin of a CPU, a memory, or the like is less than a prescribed threshold occurs due to a rapid increase in traffic or the like, duplicate transmission of the same data is temporarily stopped. Specifically, the communication line having the best line quality is left among the communication lines 22 and 24 transmitting the same data, and the communication by the other lines is temporarily stopped. The software wireless device 10 can improve the situation of resource shortage with this function.

9. In the present embodiment, the purpose of duplicate transmission of the same data through a plurality of communication lines 22 and 24 is to ensure redundancy in preparation for quality deterioration of the communication lines. Therefore, when the plurality of communication lines 22 and 24 provide a quality sufficiently higher than the threshold for determining the quality of the line (Condition 1), it is less necessary to continue the duplicate transmission. On the other hand, if there is sufficient margin in communication resources (Condition 2), there is no problem in maintaining both communication lines 22 and 24. Therefore, in the present embodiment, under the condition that both of Conditions 1 and 2 are satisfied, data from the wire is distributed to the plurality of communication lines 22 and 24 and the duplicate transmission is switched to parallel transmission. Thus, according to the software wireless device 10 of the present embodiment, the transmission capacity can be increased by the number of communication lines under an environment in which the communication state is good. When there is the margin in the resource, a newly constructed line may be added to a plurality of communication lines used for duplicate transmission to perform parallel transmission.

In the above example, the same data is transmitted through the two communication lines 22 and 24, but the number thereof is not limited to two. The number of communication lines for performing duplicate communication may be three or more.

Further, in the above example, when deterioration of line quality is detected, the software wireless device 10 on the transmitting side that has received the notification scans a new frequency band and notifies the software wireless device 10 on the receiving side of the found frequency band. However, the scanning and notification may be performed by the software wireless device 10 on the receiving side.

In addition, in the above example, the same communication system A is used for all the communication lines, but the present disclosure is not limited thereto. For example, the communication lines 22 and 24 may transmit the same data by different communication systems (for example, a WiFi (registered trademark) system or an LTE system). Further, the communication line 26 to be switched may use a system different from the communication system of the communication lines 22 and 24. In this case, it is desirable to provide the communication line 26 after switching with a transmission capacity equal to or larger than that of the communication line 24 before switching.

Further, in the above example, the same modulation method (BPSK, QPSK, 8PSK, or the like) is used for all communication lines, but the present disclosure is not limited thereto. For example, the communication lines 22 and 24 may transmit the same data by different modulation systems. Further, the communication line 26 to be switched may use a system different from the modulation system of the communication lines 22 and 24. In the case of scanning a new frequency band, a modulation system for providing the best communication quality may be selected in the same frequency band. In this case, it is desirable to provide the communication line 26 after switching with a transmission capacity equal to or larger than that of the communication line 24 before switching.

[Specific Configuration of Embodiment 1]

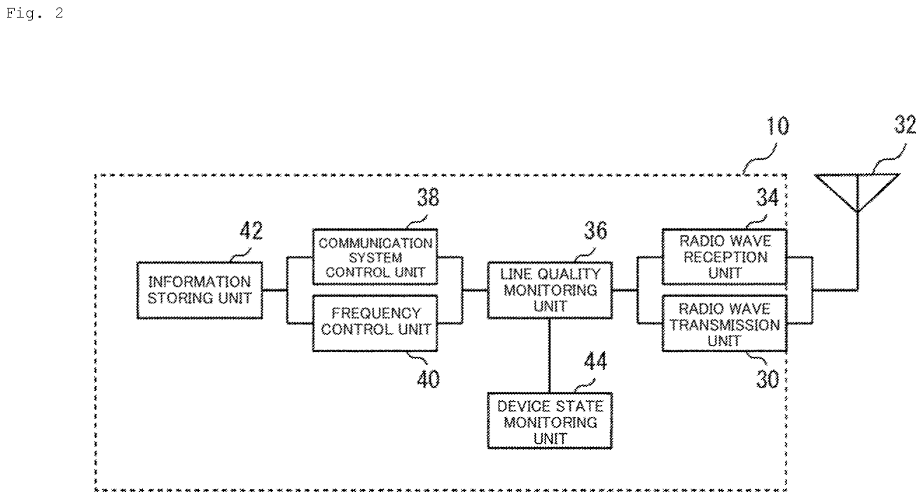

FIG. 2 is a block diagram for illustrating elements configured inside the software wireless device 10 illustrated in FIG. 1. As illustrated in FIG. 2, the software wireless device 10 includes a radio wave transmission unit 30. The radio wave transmission unit 30 modulates a signal input from the wired terminal 20 (see FIG. 1) into a transmission signal, and transmits the signal through the antenna 32. The software wireless device 10 also includes a radio wave reception unit 34. The radio wave reception unit 34 demodulates the wireless signal received by the antenna 32 into a reception signal and provides the demodulated signal to the wired terminal 20.

The software wireless device 10 further includes a line quality monitoring unit 36. The line quality monitoring unit 36 monitors deterioration in line quality of each communication line constituted in the software wireless device 10 based on information on line quality provided through the radio wave reception unit 34. When a characteristic value representing the line quality falls below a predetermined threshold, it is determined that the line has deteriorated.

The result of the deterioration determination by the line quality monitoring unit 36 is provided to a communication system control unit 38 and a frequency control unit 40. The communication system control unit 38 selects a communication system of transmission and reception performed via the antenna 32 from a plurality of systems prepared in advance. The selected communication system is reflected on the hardware configuration of the software wireless device 10 and held in an information storing unit 42.

The frequency control unit 40 performs processing for securing a frequency band necessary for the selected communication system. When the result of the deterioration determination of the line quality is received from the line quality monitoring unit 36, processing for securing another frequency band in which good line quality is obtained is performed. The information on the frequency band set by the frequency control unit 40 is reflected on the hardware configuration of the software wireless device 10 and held in the information storing unit 42 similarly to the information of the communication system.

The software wireless device 10 also includes a device state monitoring unit 44. The device state monitoring unit 44 monitors an operation state of the hardware resources such as a CPU and a memory. In a case where a situation of resource shortage is detected, only the line having the best line quality among the communication lines transmitting the same data is left, and communication by the other lines is temporarily stopped. On the other hand, in a case where the line quality that sufficiently exceeds the threshold is ensured for multiple communication lines, and sufficient resources are available, issues an instruct to start parallel transmission in which the data from the wired terminal 20 is distributed to the plurality of communication lines.

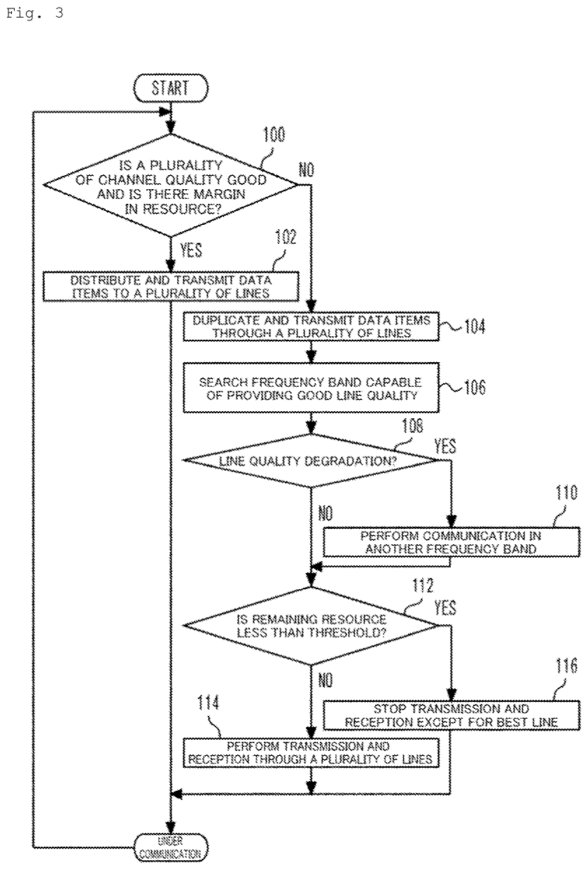

FIG. 3 is a flow chart of processing executed by the control unit 18 of the software wireless device 10 to realize the above-mentioned function. In the routine illustrated in FIG. 3, first of all, the line quality and the communication resource are determined (step 100). Specifically, it is determined whether the good line quality is obtained in a plurality of communication lines transmitting the same data (Condition 1). Further, it is determined whether the sufficient margin is recognized in resources such as a CPU and a memory or the like or not (Condition 2).

If both Condition 1 and Condition 2 are satisfied, the determination in step 100 is satisfied. In this case, switching is performed from a state where the same data are redundantly transmitted through a plurality of communication lines to a state where the data are distributed to the plurality of communication lines and transmitted in parallel (step 102). The switching to the parallel transmission is notified to the software wireless device 10 on the receiving side. Thereafter, as long as both Conditions 1 and 2 are satisfied, communication by parallel transmission is continued.

In the environment in which at least one of Conditions 1 and 2 is not established, the determination in step 100 is negative. In this case, a state for duplicating the data input from the wired terminal 20 and duplicating the same data from the plurality of communication lines 22 and 24 is reconfigured (step 104). The duplicate transmission of the same data is reported to the software wireless device 10 on the receiving side.

In a case where the same data items are transmitted in duplicate, the software wireless device 10 on the receiving side demodulates only a signal from the communication line having the best communication quality and provides the signal to the wired terminal 20. Thus, even if the communication quality has deteriorated in a part of the communication lines 22 and 24, the software wireless device 10 on the receiving side can maintain a good communication state.

Next, in the software wireless device 10 on the transmitting side, another frequency band capable of providing good line quality is searched for each of the available communication systems (step 106). The information on the frequency band found as a result is held in the information storing unit 42.

Next, it is determined whether the deterioration of the line quality is recognized in any communication line used for communication (step 108). As a result, in a case where the deterioration in the line quality is recognized, the communication on the deteriorated line is stopped, and the communication on the line using the other frequency band found in the step 106 is started (step 110).

In a case where the deterioration of the line quality is not recognized in the step 108, and after the execution of the step 110, it is determined whether the characteristic value representing the remaining degree of the hardware resource is below the threshold or not (step 112). In a case where the characteristic value is lower than the threshold, the resource shortage of the hardware is determined.

In a case where the resource shortage of the hardware is not recognized by the above processing, the state of duplicate transmission for transmitting the same data through the plurality of communication lines is continued (step 114).

On the other hand, when the resource shortage of the hardware is recognized, the communication on the other communication lines is stopped while leaving the line of the best line quality among the plurality of communication lines transmitting the same data (step 116). The stop of the communication in the other communication line is notified to the software wireless device 10 on the receiving side. Thereafter, the communication on the lines is stopped, and the resources of the hardware used for the communication are released to other applications. Thus, the resource shortage of hardware is eliminated.

### Embodiment 2

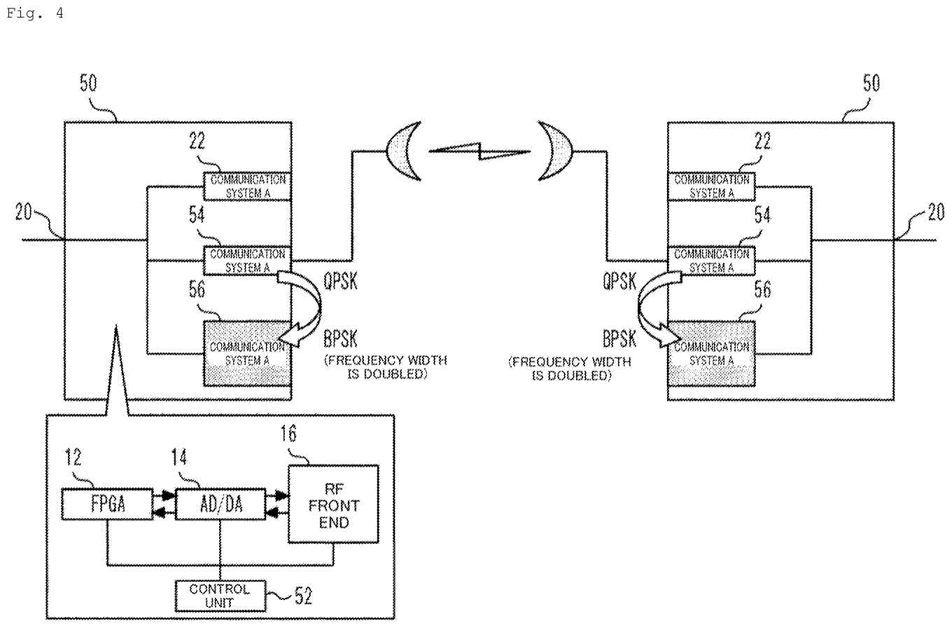

Next, Embodiment 2 of the present disclosure will be described with reference to FIGS. 4 to 6.

FIG. 4 is a diagram illustrating a configuration of a software wireless device 50 of the present embodiment. As in Embodiment 1, the software wireless device 50 of the present embodiment includes hardware which can be reconfigured by software, and the frequency band and the communication system used for wireless communication can be changed as necessary. In FIG. 4, the same elements as those illustrated in FIG. 1 are designated by a common reference numeral, and the description thereof will be omitted or simplified.

The software wireless device 50 of the present embodiment includes a control unit 52. The control unit 52 is similar to the control unit 18 in Embodiment 1 in that the FPGA 12, the AD/DA converter 14 and the RF front end unit 16 are controlled. In addition, the control unit 52 can realize the following functions in addition to the functions similar to those of the control unit 18. Hereinafter, the features of the software wireless device 50 of the present embodiment will be described.

[Feature of Embodiment 2]

In FIG. 4, three communication lines 22, 54, and 56 using the communication system A are formed in the software wireless device 50. In the software wireless device 70 on the transmitting side, the communication line 54 transmits the same data as the communication line 22. Then, the software wireless device 50 on the receiving side provides only the data received by the line having the excellent line quality among the communication lines 22 and 52 to the priority terminal 20, as in the case of Embodiment 1. In the example illustrated in FIG. 4, however, it is assumed that the communication line 54 transmits data by a quadrature phase shift keying (QPSK) modulation system.

The software wireless device 50 of the present embodiment can change the modulation system so that the number of multi-values changes according to the communication environment using the adaptive modulation technique. Specifically, as the modulation system, not only QPSK having a multi-value number of 4 but also binary phase shift keying (BPSK) with a multi-value number of 2 can be used. Further, 256 quadrature amplitude modulation (QAM), 64QAM, 16QAM, or the like, which have different numbers of multiple values, can be used properly.

The larger the number of multi-values, the larger the transmission capacity, but the communication tends to become unstable. For this reason, in an environment in which good line quality is easily obtained, it is preferable to increase the number of multi-values to secure a large transmission capacity. On the other hand, in an environment in which good line quality is difficult to be obtained, it is desirable to reduce the number of multi-values to improve the stability of communication.

In FIG. 4, rectangular frames illustrating the communication lines 22, 54, and 56 represent the height of the “frequency band” used by the respective communication lines and the width of the frequency band, as in the case illustrated in FIG. 1. In particular, in here, the communication lines 22 and 54 have the same frequency band width, whereas the communication line 56 has a frequency band width twice that of the communication line. FIG. 4 illustrates that a BPSK modulation system is used in the communication line 56. When BPSK is used, the multi-value number becomes half as compared with the case where QPSK is used, but if the frequency band width of twice is secured, the same transmission capacity as that of the communication line 54 can be secured by the communication line 56. Therefore, the communication line 56 illustrated in FIG. 4 can be used as a substitute for the communication line 54.

In the present embodiment, when data is transferred through a plurality of communication lines 22 and 54, the control unit 52 searches for whether there is a frequency band capable of providing good line quality with a wider frequency band width than those of the communication lines. In a case where a frequency band capable of securing the same transmission capacity while reducing the number of multi-values is found, a modulation system for reducing the number of multi-values is selected, and the existing communication is switched to communication in a new frequency band. In this case, the changed modulation system and the frequency band are notified to the software wireless device 50 on the receiving side by a predetermined wireless communication system. When the number of multi-values decreases, the stability of communication is improved as described above. Therefore, the software wireless device 50 of the present embodiment can provide communication with more excellent robustness than the software wireless device 10 of Embodiment 1.

[Specific Configuration of Embodiment 2]

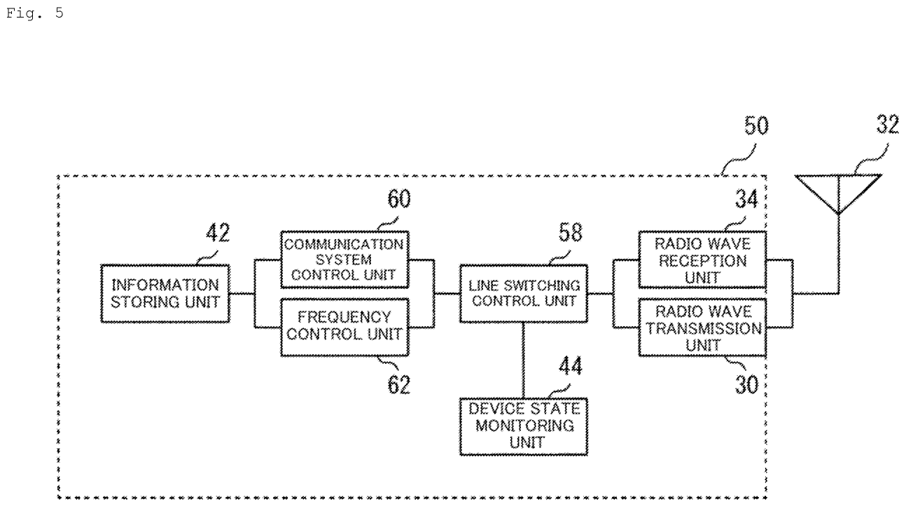

FIG. 5 is a block diagram for illustrating elements configured inside the software wireless device 50 illustrated in FIG. 4. The configuration illustrated in FIG. 5 is the same as the configuration illustrated in FIG. 2 except that the line quality monitoring unit 36, the communication system control unit 38, and the frequency control unit 40 are replaced by a line switching control unit 58, a communication system control unit 60, and a frequency control unit 62, respectively. The same elements as those illustrated in FIG. 2 in FIG. 5 are designated by a common reference numeral, and the description thereof will be omitted or simplified.

The line switching control unit 58 has the same function as the line quality monitoring unit 36 in Embodiment 1. Further, in a case where switching to the modulation system with a small number of multi-values is possible by one or more communication systems, the line switching control unit 58 issues an instruction to switch the communication line using the communication system to the modulation system with a small number of multi-values. This switching is performed regardless of whether the quality of the communication line before the switching is deteriorated.

As in the communication system control unit 38 in Embodiment 1, the communication system control unit 60 selects a communication system for transmission and reception performed via the antenna 32 from a plurality of systems prepared in advance. Further, the communication system control unit 60 searches for a communication system capable of communication by a modulation system with a small number of multi-values. The combination of the searched communication system and the modulation system is held in the information storing unit 42.

The frequency control unit 62 has the same function as that of the frequency control unit 40 in Embodiment 1. Further, the frequency control unit 62 secures a frequency band necessary for using the combination of the communication system and the modulation system selected by the communication system control unit 60. When switching to a modulation system having a smaller number of multi-values than that of a communication line under communication, a frequency band width capable of securing a transmission capacity equal to or more than that before switching is secured with a large number of values after switching. The information on the frequency band set by the frequency control unit 62 is held in the information storing unit 42 in the same manner as the information of the communication system.

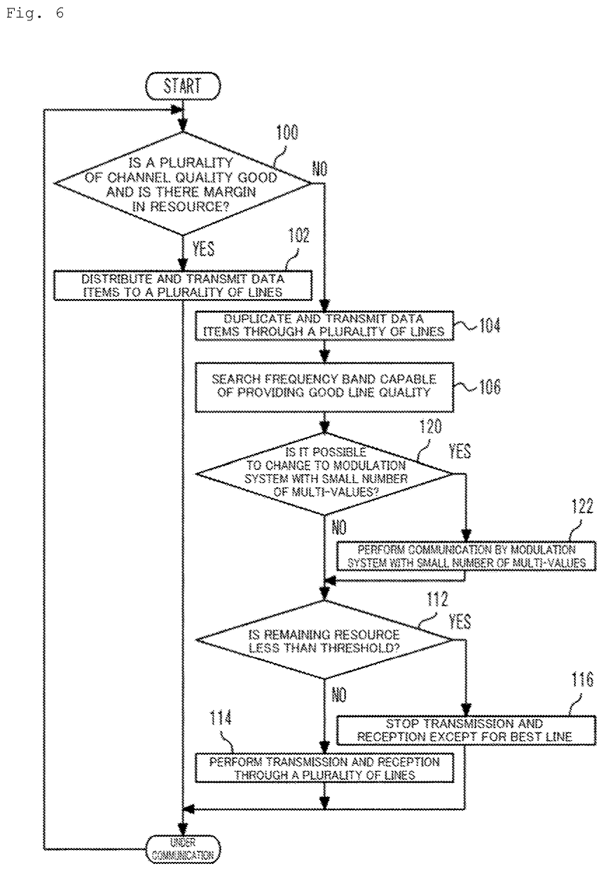

FIG. 6 is a flow chart of the processing executed by the control unit 52 of the software wireless device 50 in order to realize the above-mentioned function. The flowchart illustrated in FIG. 6 is similar to the flowchart illustrated in FIG. 3 except that steps 108 and 110 are replaced by steps 120 and 122, respectively. Among the steps illustrated in FIG. 6, steps similar to those illustrated in FIG. 3 are denoted by common reference numerals, and description thereof will be omitted or simplified.

In the routine illustrated in FIG. 6, after a frequency band capable of providing good line quality is searched in step 106, it is determined whether at least one of communication lines under communication can be changed to a modulation system having a small number of multi-values (step 120). Here, the following conditions are determined.

1. At least one of the communication lines in use uses a modulation system capable of switching to another modulation system with a small number of multi-values (Condition a).

2. In a case where the modulation system of the communication line satisfying Condition a is changed to a modulation system having a small number of multi-values, is it possible to secure a frequency bandwidth that can secure a desired transmission capacity, preferably a transmission capacity equal to or higher than that before the change, in the frequency band found in step 106 (Condition b)?

In a case where either Condition a or Condition B is not established, the determination in step 120 is not established. In this case, processing elements after step 112 are immediately executed thereafter. As a result, as long as the resource permits, duplicate transmission on the current communication line is continued.

On the other hand, in a case where it is determined that both Condition a and Condition b are established in the step 120, communication by a modulation system with a small number of multi-values is started next (step 122). Specifically, the following processing elements are executed here.

1. Communication on the communication line determined to be able to switch to the modulation system with a small number of multi-values is stopped.

2. Communication on a new communication line is started by using the modulation system with a small number of multi-values and a frequency band width extended to obtain a necessary transmission capacity.

According to the above processing elements, the same data can be transmitted in duplicate by utilizing a wide frequency band by using a modulation system having a low multi-value number.

Therefore, according to the present embodiment, communication with higher robustness can be provided as compared with the case of Embodiment 1.

In Embodiment 2 described above, the switching for lowering the multi-value number is performed without detecting the deterioration of the line quality. However, the present disclosure is not limited thereto. The switching for lowering the multi-value number may be performed when the quality deterioration of the communication line under communication is recognized, as in the switching in Embodiment 1.

### Embodiment 3

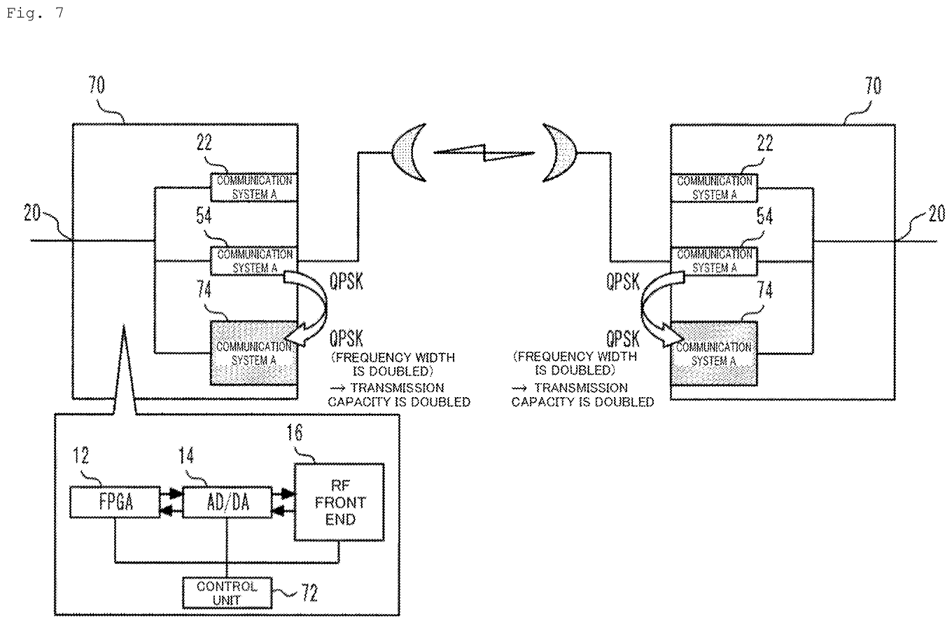

Next, Embodiment 3 of the present disclosure will be described with reference to FIGS. 7 to 9.

FIG. 7 is a diagram illustrating a configuration of a software wireless device 70 according to the present embodiment. As in Embodiment 1, the software wireless device 70 of the present embodiment includes hardware which can be reconfigured by software, and the frequency band and the communication system used for wireless communication can be changed as necessary. In FIG. 7, the same elements as those illustrated in FIG. 1 or FIG. 4 are designated by a common reference numeral, and the description thereof will be omitted or simplified.

The software wireless device 70 of the present embodiment includes a control unit 72. The control unit 72 is similar to the control unit 18 in Embodiment 1 in that the FPGA 12, the AD/DA converter 14 and the RF front end unit 16 are controlled. In addition, the control unit 72 can realize the following functions in addition to the functions similar to those of the control unit 18. Hereinafter, the features of the software wireless device 70 of the present embodiment will be described.

[Feature of Embodiment 3]

In FIG. 7, three communication lines 22, 54, and 74 using the communication system A are formed in the software wireless device 70. In the software wireless device 50 on the transmitting side, the communication line 54 transmits the same data as the communication line 22 using the QPSK modulation system, as in the case of Embodiment 2. The software wireless device 70 on the receiving side provides only the data received by the line with excellent line quality to the priority terminal 20. Thus, the software wireless device 70 can realize stable data communication as in Embodiment 1 or 2.

The software wireless device 70 of the present embodiment searches for whether the frequency band width can be expanded by one or more communication systems. In a case where the communication system capable of expanding the band width exists, the communication line whose transmission capacity is insufficient is preferentially switched to the communication line whose band width is wide.

In FIG. 7, rectangular frames illustrating the communication lines 22, 54, and 74 represent the height of the “frequency band” used by the respective communication lines and the width of the frequency band, as in the case illustrated in FIG. 1. In here, the communication lines 22 and 54 have the same frequency band width, whereas the communication line 74 has a frequency band width twice that of the communication line. FIG. 7 illustrates that the modulation system used in the communication line 74 is the same QPSK modulation system as the modulation system of the communication line 54.

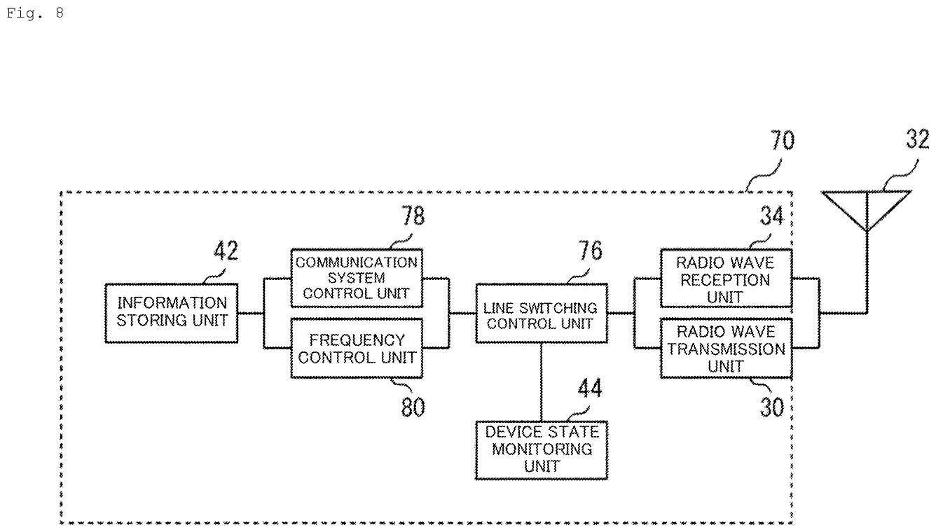

If the communication line 74 has a frequency band twice that of the communication line 54 by using QPSK using the same multi-value number as that of the communication line 54, the transmission capacity becomes twice that of the communication line 54. Then, in the present embodiment, in a case where the communication line 74 is available, the control unit 72 preferentially switches the communication line having insufficient transmission capacity, for example, the communication line 54 to the communication line 74. Therefore, the software wireless device 70 of the present embodiment can provide more excellent communication quality than the software wireless device 10 of Embodiment 1.

[Specific Configuration of Embodiment 3] FIG. 8 is a block diagram for illustrating elements configured inside the software wireless device 70 illustrated in FIG. 7. The configuration illustrated in FIG. 8 is the same as the configuration illustrated in FIG. 2 except that the line quality monitoring unit 36, the communication system control unit 38, and the frequency control unit 40 are replaced by a line switching control unit 76, a communication system control unit 78, and a frequency control unit 80, respectively. The same elements as those illustrated in FIG. 2 in FIG. 8 are designated by a common reference numeral, and the description thereof will be omitted or simplified.

The line switching control unit 76 has the same function as the line quality monitoring unit 36 in Embodiment 1. Further, in a case where it is possible to communicate by expanding the frequency bandwidth with one or more communication systems, the line switching control unit 76 issues an instruction to switch the communication line using the communication system to the communication line using the extended frequency band. This switching is performed preferentially to a communication line whose transmission capacity is insufficient regardless of whether the quality of the communication line before the switching is deteriorated.

As in the communication system control unit 38 in Embodiment 1, the communication system control unit 78 selects a communication system for transmission and reception performed via the antenna 32 from a plurality of systems prepared in advance. Further, the communication system control unit 78 searches for a communication system capable of performing communication by increasing the transmission capacity by expanding the frequency band width. The searched communication system is held in an information storing unit 42.

The frequency control unit 80 has the same function as that of the frequency control unit 40 in Embodiment 1. Further, the frequency control unit 80 secures a frequency band wider than a frequency band under communication. The information of the frequency band set by the frequency control unit 80 is held in the information storing unit 42 in the same manner as the information of the communication system.

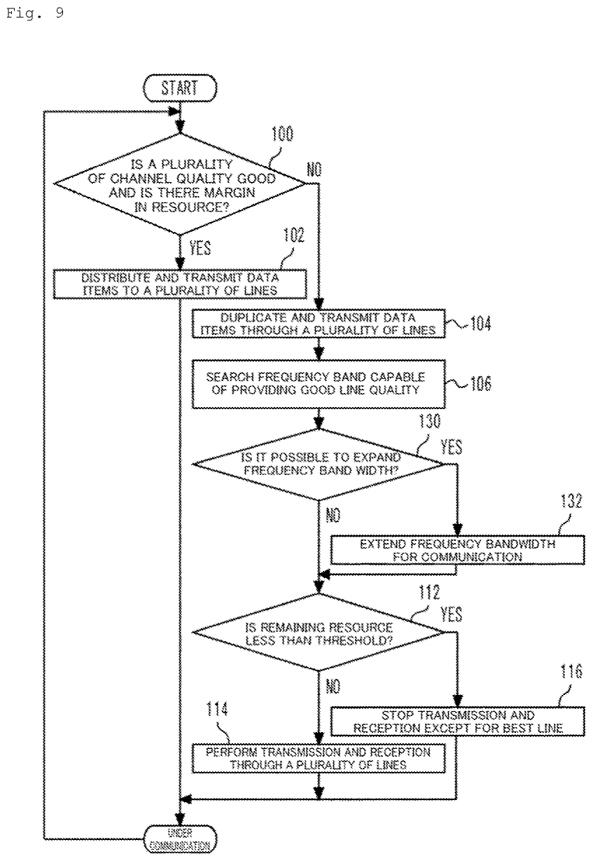

FIG. 9 is a flowchart of processing executed by the control unit 72 of the software wireless device 70 in order to realize the above functions. The flowchart illustrated in FIG. 9 is similar to the flowchart illustrated in FIG. 3, except that steps 108 and 110 are replaced by steps 130 and 132, respectively. Hereinafter, among the steps illustrated in FIG. 9, steps similar to those illustrated in FIG. 3 are denoted by common reference numerals, and description thereof will be omitted or simplified.

In the routine illustrated in FIG. 9, after a frequency band capable of providing good line quality is searched in step 106, it is determined whether a communication system capable of extending the frequency band width exists in the available communication systems or not (step 130).

As a result, if it is determined that there is no communication system capable of extending the frequency band width, the processing of step 112 and subsequent steps is immediately executed. As a result, as long as the communication resource permits, duplicate transmission using the currently used communication line is continued.

On the other hand, in the step 130, in a case where it is determined that there is a communication system that can expand the frequency bandwidth, next, in that communication system, data communication using the expanded frequency bandwidth is started (step 132). Specifically, the following processing elements are executed here.

1. Communication is stopped on a line whose transmission capacity is the most insufficient among the communication lines in use.

2. The communication is started with the extended frequency band width by switching to the line. However, the communication after switching is performed by the communication system found in step 130 and by a modulation system in which the number of multi-values before switching is maintained.

According to the above processing elements, when the transmission capacity of the communication line under communication is insufficient, the communication line is switched to a line having a larger transmission capacity as long as the communication resource permits, and the communication is continued. Therefore, according to the present embodiment, communication with less packet loss can be provided as compared with the case of Embodiment 1.

### REFERENCE SIGNS LIST

10, 50, 70 Software wireless device
18, 52, 72 Control unit
22, 24, 26, 54, 56, 74 Communication line
36 Line quality monitoring unit
38, 60, 78 Communication system control unit
40, 62, 80 Frequency control unit
58, 76 Line switching control unit

1. A software wireless device comprising:
hardware resources for wireless communication that can be reconfigured by changing software;
a memory storing software for making the hardware resources compatible with wireless communication; and
a control unit that reconfigures the hardware resources using the software stored in the memory, wherein
the control unit executes
processing of configuring communication resources responsible for wireless communication on a plurality of communication lines with different frequency bands,
processing to transmit the same data items on the plurality of communication lines,
processing of handling data received by a communication line having the best line quality among a plurality of communication lines receiving the same data items as valid data,
processing of searching for another frequency band different from the frequency band used in the plurality of communication lines and capable of providing line quality exceeding a determination criterion,
processing of configuring a communication resource responsible for wireless communication on the additional communication line using the other frequency band, and
processing of switching one of the plurality of communication lines to the additional communication line.

2. The software wireless device according to claim 1, wherein the switching processing includes
processing of detecting line quality of each of the plurality of communication lines, and
processing of switching the communication line to the additional communication line when deterioration in line quality is detected in one of the plurality of communication lines.

3. The software wireless device according to claim 1, wherein the switching processing includes
processing of determining whether at least one of the plurality of communication lines uses a modulation system that can be changed to another modulation system having a small number of multivalues,
processing of determining whether the other frequency band includes a frequency band width capable of securing a desired transmission capacity by the other modulation system, and
processing of switching the communication line of the plurality of communication lines using the modulation system to the additional communication line in a case where the two determinations are affirmed, and
the additional communication line has the frequency bandwidth and is configured as a line using the other modulation system.

4. The software wireless device according to claim 1, wherein the switching processing includes
processing of determining whether at least one of the plurality of communication lines has an expandable frequency band width, and
processing of, in a case where the determination is affirmed, switching the communication line whose frequency bandwidth can be expanded to the additional communication line, which has the shortest transmission capacity, and
the additional communication line is configured as a line having a frequency band width that is extended compared to a communication line before switching.

5. The software wireless device according to claim 1, wherein the control unit further executes
processing of determining whether the line quality of the plurality of communication lines exceeds the determination criterion,
processing of determining whether a margin of the hardware resources is less than the determination criterion, and
processing of, in a case where the two determinations are affirmative, reconfiguring the hardware resources so that data transmitted and received in duplicate by the plurality of communication lines is distributed to the plurality of communication lines and transmitted and received in parallel.

6. The software wireless device according to claim 1, wherein the control unit further executes
processing of determining a line having the highest line quality among the plurality of communication lines,
processing of determining whether the margin of the hardware resources is below the determination criterion, and
processing of, in a case where the determination is affirmative, releasing the hardware resources allocated to other communication lines excluding a line having the highest line quality among the plurality of communication lines from communication resources used for communication of the same data.

7. A method for avoiding deterioration of line quality using hardware resources for wireless communication that can be reconfigured by changing software and software for making the hardware resources compatible with wireless communication, the method comprising:
a control step of reconfiguring the hardware resources using the software, wherein the control step includes
a step of configuring communication resources responsible for wireless communication on a plurality of communication lines with different frequency bands,
a step of transmitting the same data items on the plurality of communication lines,
a step of handling data received by a communication line having the best line quality among a plurality of communication lines receiving the same data items as valid data,
a step of searching for another frequency band different from the frequency band used in the plurality of communication lines and capable of providing line quality exceeding a determination criterion,
a step of configuring a communication resource responsible for wireless communication on the additional communication line using the other frequency band, and
a step of switching one of the plurality of communication lines to the additional communication line.

8. A non-transitory computer-readable medium having computer-executable instructions that, upon execution of the instructions by a processor of a computer, cause the computer to function as the software wireless device according to claim 1 in a computer.
